(19) United States
(12) Patent Application Publication
(10) Pub. No.: US 2024/0390903 A1
(43) Pub. Date: Nov. 28, 2024

(54) FLOW CELL INTERFACE ADAPTOR

(71) Applicant: Genome Research Limited, Hinxton (GB)

(72) Inventors: Omer Bayraktar, Hinxton (GB); Kenny Roberts, Hinxton (GB); Kwasi Kwakwa, Hinxton (GB); Andrew Ede, Stow-cum-Quy (GB); Oliver Godbold, Stow-cum-Quy (GB); Colin Kemp, Stow-cum-Quy (GB); Maxwell Walker, Stow-cum-Quy (GB)

(21) Appl. No.: 18/694,346

(22) PCT Filed: Sep. 21, 2022
(86) PCT No.: PCT/GB2022/052378

§ 371 Date: Mar. 21, 2024

(30) Foreign Application Priority Data
Sep. 23, 2021 (GB) 2113547.0

(51) Int. Cl. B01L 3/00

(52) U.S. Cl. CPC B01L 3/502746; B01L 3/502715; B01L 2200/027; B01L 2200/0642; B01L 2200/16; B01L 2300/0877; B01L 2300/18

(57) ABSTRACT

A flow cell adaptor for use in cyclic histology, the flow cell adaptor having a body defining a cavity configured to removably receive a flow cell, wherein the adaptor has a fluid input channel configured to direct one or more reagents to a flow cell, and a fluid output channel configured to receive one or more reagents from a flow cell, wherein the flow cell adaptor comprises a heater configured to heat the one or more reagents in the fluid input channel.

The present disclosure relates to a flow cell adaptor for use in cyclic histology, and to a system including a flow cell and a flow cell adaptor.

In immunohistochemistry, and other staining techniques employed in histology, markers are applied to a sample containing a tissue to be analysed. The markers bind with certain target molecules (for example certain genes), and allows the molecules to be imaged.

Typically, only a few target molecules (often less than five) can be imaged at once. However, to perform full analysis of a sample, it may be necessary image hundreds of molecules or more. In order to achieve this, the markers are quenched, flushed from the sample, and new markers are applied for imaging further molecules. This is repeated on a cyclical basis.

In many situations, it is necessary to analyse a large number of tissue samples, imaging hundreds of molecules for each sample. For example, where a large three dimensional tissue sample is to be analysed, and it is desired to obtain information on the three dimensional arrangement of the sample, the sample has to be sliced into thin layers, and each layer analysed separately as independent samples. A number of these larger three dimensional samples may need to be analysed in this way.

According to a first aspect of the invention there is provided a flow cell adaptor for use in cyclic histology, the flow cell adaptor having a body defining a cavity configured to removably receive a flow cell, wherein the adaptor has a fluid input channel configured to direct one or more reagents to a flow cell, and a fluid output channel configured to receive one or more reagents from a flow cell, wherein the flow cell adaptor comprises a heater configured to heat the one or more reagents in the fluid input channel.

The adapter allows for the automation of histology imaging of a large number of samples. The use of the heater to pre-heat reagents before they enter the flow cell ensure the process is efficient and simple to perform. The adapter is simple to construct and use.

The cavity is sized to fit a flow cell which comprises a microscope slide.

The flow cell and an outlet of the fluid input channel and an inlet of the fluid output channel may be biased such that they are urged together.

The body may be formed of two or more parts which may be removably fixed together such that the flow cell can be removed from the cavity.

The adaptor may include a biasing block which may be received at least partially within the cavity. The biasing block may be urged away from a first portion of the body towards the flow cell, which in turn urges the fluid input and output channels and the flow cell together.

The biasing block may incorporate the heater such that the heater heats the block.

At least a portion of the fluid input channel may run through the biasing block to pre-heat the one or more fluids.

At least a portion of the fluid input channel may run adjacent to the biasing block to pre-heat the one or more fluids.

The body may define an opening through which the contents of the flow cell can be imaged.

The body may comprise a ledge configured to support the flow cell.

In use, the flow cell may be supported by the ledge at opposing ends only.

The ledge may be configured to support the flow cell on a first side of the flow cell, and the biasing force may act on a second side of the flow cell, opposite the first side.

A portion of the fluid input channel and a portion of the fluid output channel may both be routed through the ledge.

The flow cell adapter may be sized to fit on a standard histology microscope stage.

The body may define a plurality of cavities. Each cavity may be configured to removably receive a flow cell. The adaptor may have a plurality of fluid input channels, each fluid input channel configured to direct one or more reagents to a respective flow cell. The adaptor may have a plurality of fluid output channels, each fluid output channel configured to receive one or more reagents from a respective flow cell. The flow cell adaptor may comprise one or more heaters configured to heat the one or more reagents in the fluid input channels.

The heater may pre-heat the one or more reagents in the fluid input channel and heat the flow cell.

According to a second aspect of the invention, there is provided a system for performing cyclic histology, the system comprising: a flow cell comprising: a first plate; a second plate; a gasket between the first and second plates, wherein the gasket includes an opening extending therethrough, the opening defined by a perimeter wall, such that an enclosed volume is formed by the first plate, the second plate, and the perimeter wall; and one or more fluid input holes in one of the first plate or the second plate, and one or more fluid output holes in the one of the first plate or the second plate, the one or more fluid input holes and one or more fluid output holes aligned with the enclosed volume, and a flow cell adaptor according to any of the preceding claims wherein the fluid input channel is configured to direct one or more fluids to the one or more fluid input holes, and the fluid output channel is configured to receive one or more fluids from the one or more fluid output holes.

The flow cell can be made using a standard microscope slide and coverslip. The system allows for the automation of histology imaging of a large number of samples. The use of the heater to pre-heat reagents before they enter the flow cell ensure the process is efficient and simple to perform. The system is simple to construct and use.

A single corner of the gasket may be curved.

The first plate or the second plate may be a microscope slide. One of the first plate or the second plate may be a coverslip.

The system may comprise two or more flow cells, wherein the body of the flow cell adaptor defines two or more cavities. Each cavity may be configured to removably receive a flow cell. The adaptor may have one or more fluid input channels configured to direct one or more reagents to the fluid input holes. The adaptor may have one or more fluid output channels configured to receive one or more reagents from the fluid output holes.

According to a third aspect of the invention, there is provided a device for assembling a flow cell comprising a first plate, a second plate, and a gasket between the first plate and the second plate, the device including: a first guide arranged to locate the gasket relative to one of the first plate and second plate, for forming a component part of the flow cell comprising the gasket attached to the one of the first plate and second plate; a second guide arranged to locate the component part of the flow cell relative to the other of the first plate and second plate, for forming the assembled flow cell.

The device makes it easy for a user to accurately and repeatably assemble flow cells.

The device may further include: a third guide arranged to locate the assembled flow cell such that pressure may be applied to the flow cell, to ensure adhesion of the first plate, the second plate, and the gasket.

The third guide may locate the flow cell relative to a planar surface to which pressure is applied, such that the flow cell is substantially flush to the surface.

The first guide and/or the second guide may be inclined relative to a surface on which the device is placed.

The first guide, the second guide, and the third guide where provided, may comprise an edge to locate the first plate, second plate, gasket or component part of the flow cell.

The edge may be formed by a recess extending into a planar surface or a projection extending from the planar surface.

The first guide and/or second guide may comprise both a recess extending into a planar surface, and projections extending from the planar surface, arranged around the recess.

The recess may be arranged to receive a one of the first plate, the second plate, the gasket, or the component part, such that the first plate, the second plate, the gasket, or the component part is substantially flush with the planar surface.

In the first guide, the recess may be arranged to locate the gasket and the projections are arranged to locate the one of the first plate and the second plate relative to the gasket. In the second guide, the recess may be arranged to locate the other of the first plate and the second plate and a first portion of the component part, and the projections are arranged to locate a second portion of the component part.

The recess and corresponding first plate, second plate or gasket may be shaped to only allow placement of the first plate, second plate or gasket in a single orientation.

The recess and the corresponding first plate, second plate or gasket may have a single curved corner.

The edge may be continuous or discontinuous around the perimeter of the flow cell.

The edge may be provided at one or more corners of the perimeter of the flow cell, for example, three corners of the perimeter of the flow cell.

The first guide and/or the second guide may comprise a through hole aligned with the edge of the flow cell.

The first guide, the second guide, and the third guide where provided, may be formed as separate parts.

The first guide, the second guide, and the third guide where provided may be mounted on a common base.

One of the first plate or the second plate may be a microscope slide. One of the first plate or the second plate may be a coverslip.

Features discussed in relation to one aspect of the invention may be applied to any other aspect, unless mutually exclusive.

Embodiments of the invention will now be described, by way of example only, with reference to the accompanying drawings in which;

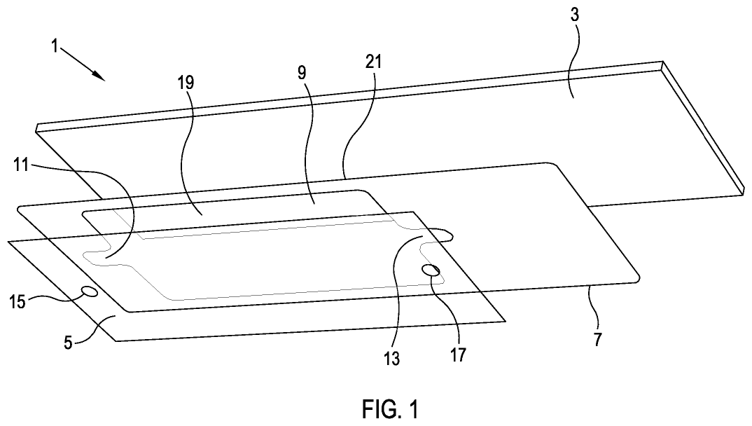

FIG. 1 illustrates a flow cell according to a first embodiment;

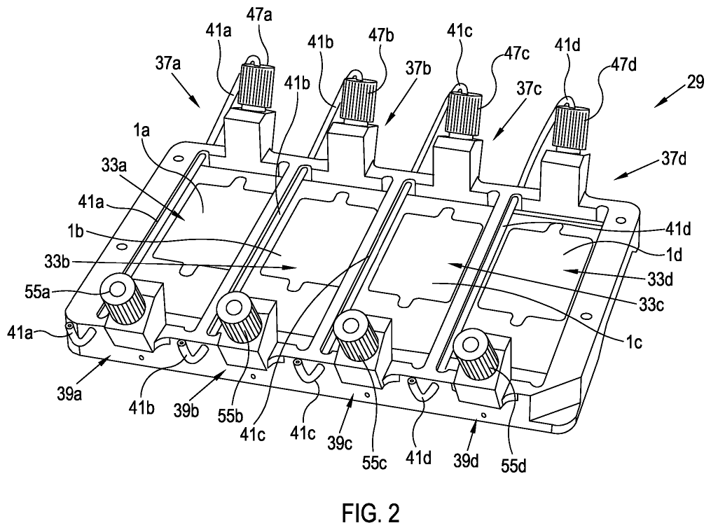

FIG. 2 illustrates the base of an adapter arranged to hold four flow cells as shown in FIG. 1;

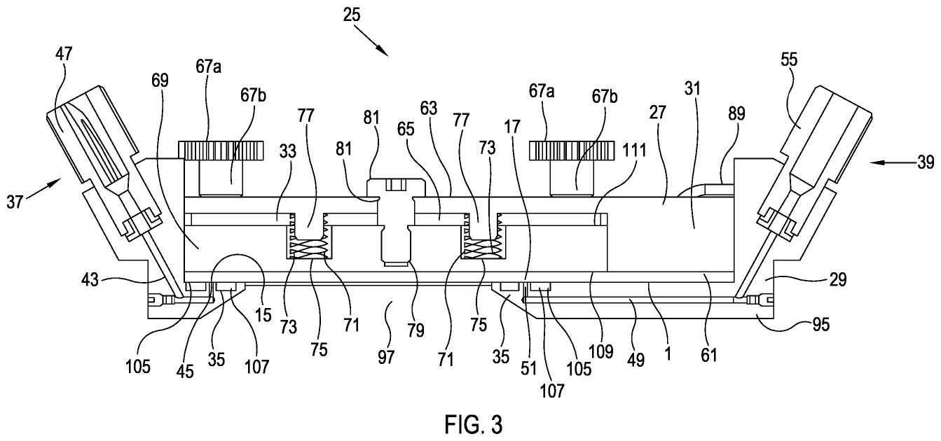

FIG. 3 illustrates an adapter including the base of FIG. 2 in cross-section through one of the flow-cells, along the length of the flow-cell;

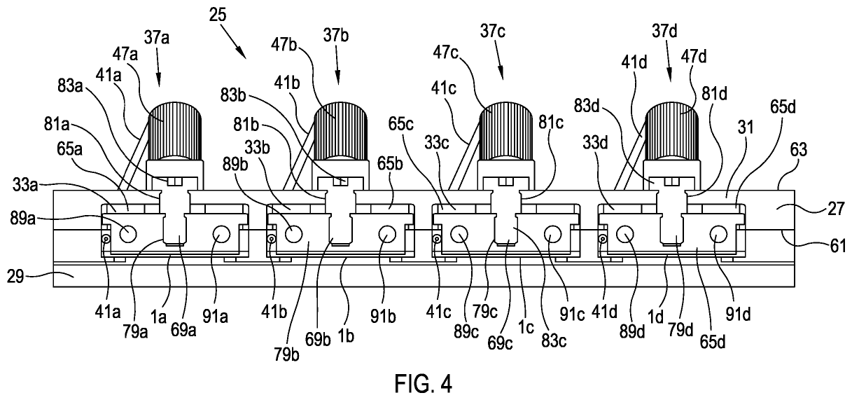

FIG. 4 illustrates the adapter of FIG. 3 in cross-section through across the flow-cells, along the width of the flow-cells;

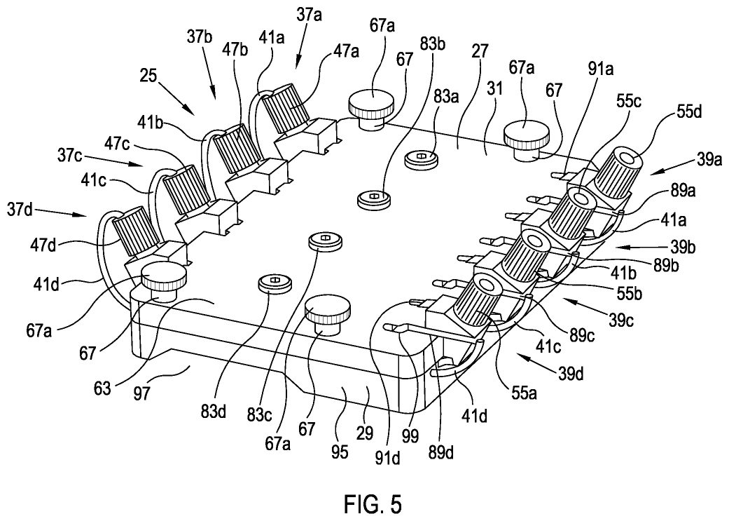

FIG. 5 illustrates a top perspective view of the assembled adapter of FIG. 3;

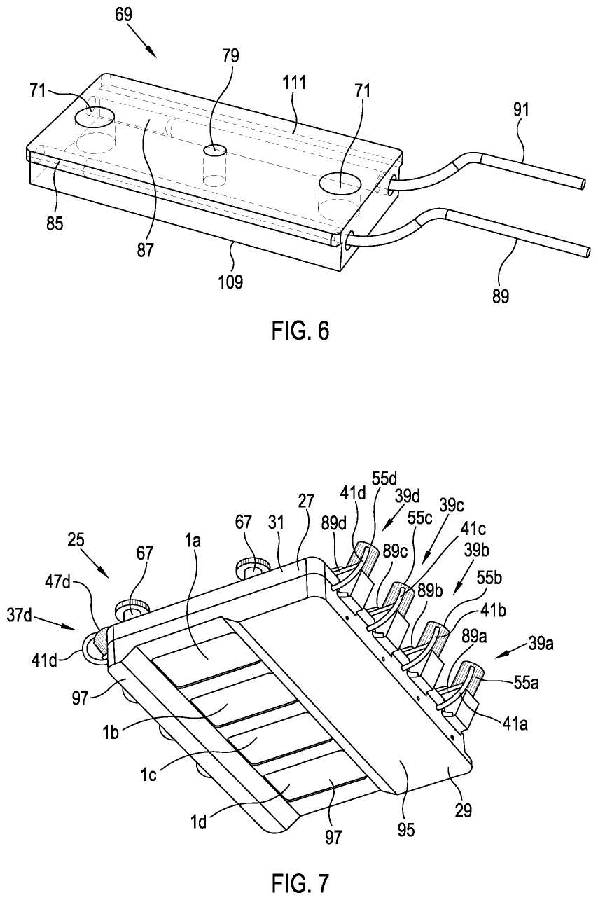

FIG. 6 illustrates a biasing block of the adapter of FIG. 3;

FIG. 7 illustrates a bottom perspective view of the assembled adapter of FIG. 3;

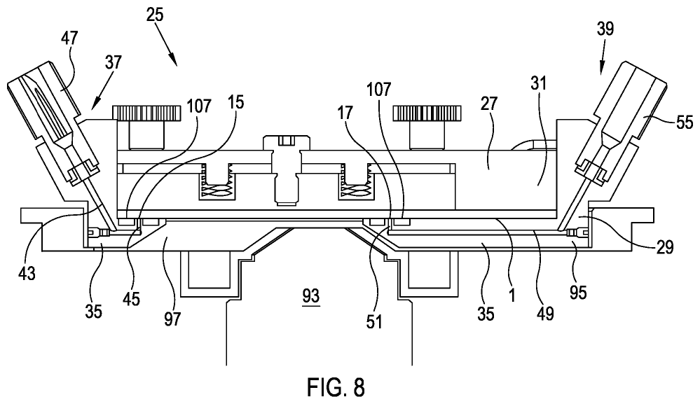

FIG. 8 illustrates the adapter of FIG. 3 in cross-section through one of the flow-cells, along the length of the flow-cell, with an imaging apparatus to image a sample held in the flow cell;

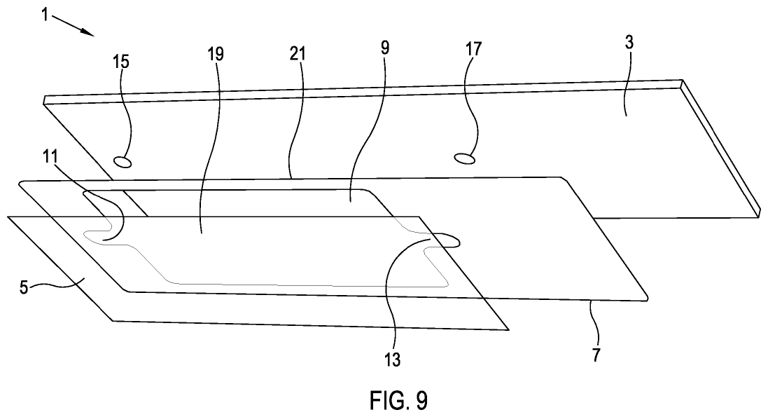

FIG. 9 illustrates a flow cell according to a second embodiment;

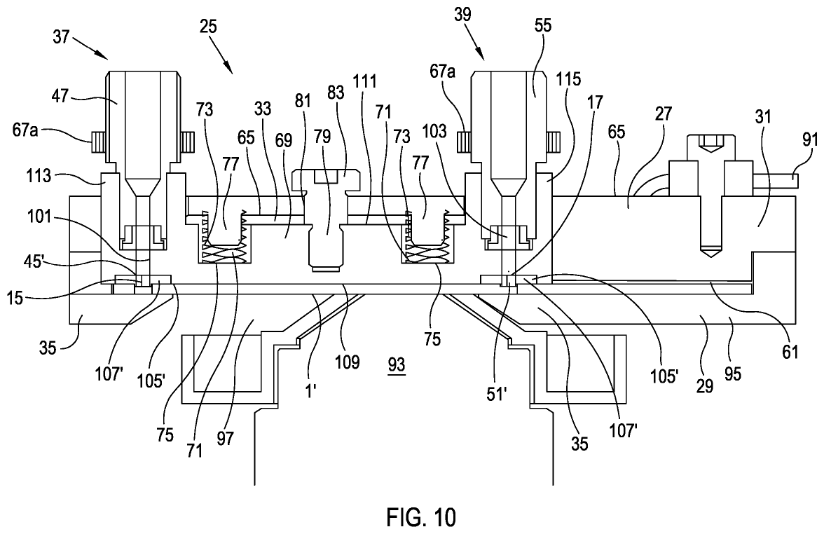

FIG. 10 illustrates an adapter holding four of the flow cells of FIG. 9, in cross-section through one of the flow-cells, along the length of the flow cell;

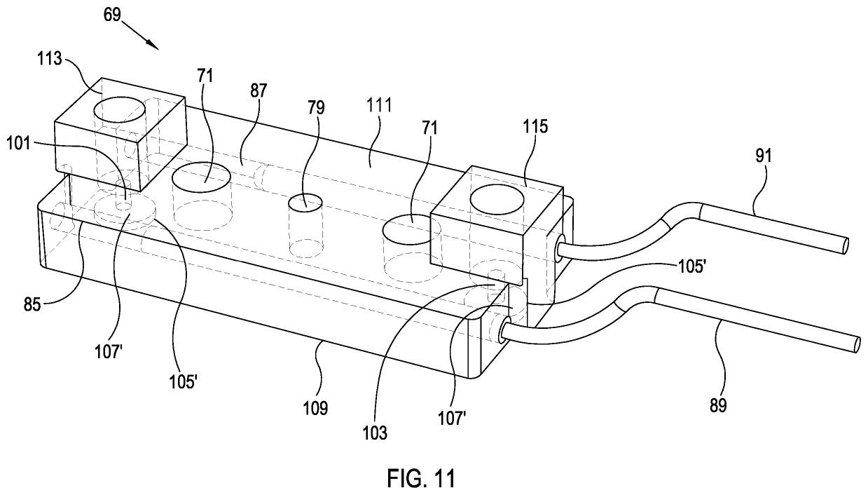

FIG. 11 illustrates the biasing block of the adapter of FIG. 10;

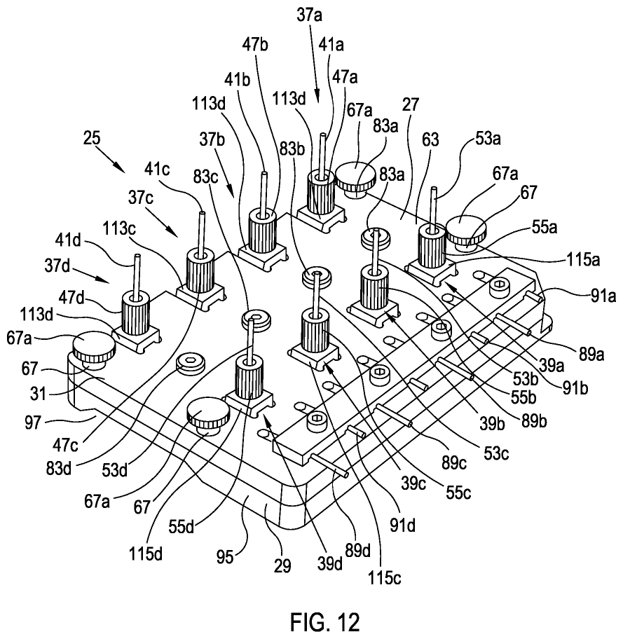

FIG. 12 illustrates the adapter of FIG. 10 in perspective view;

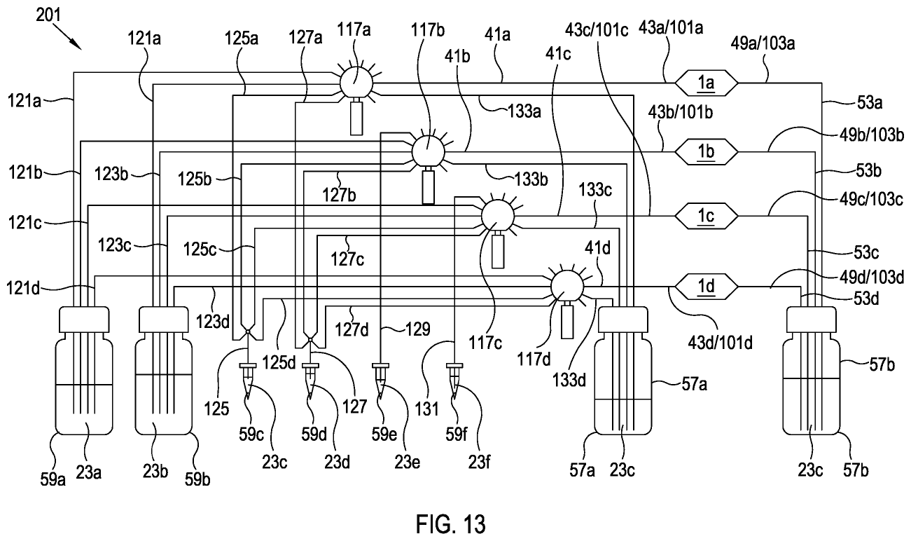

FIG. 13 schematically illustrates a system including four flow cells mounted in an adapter as shown in FIG. 3 or 10;

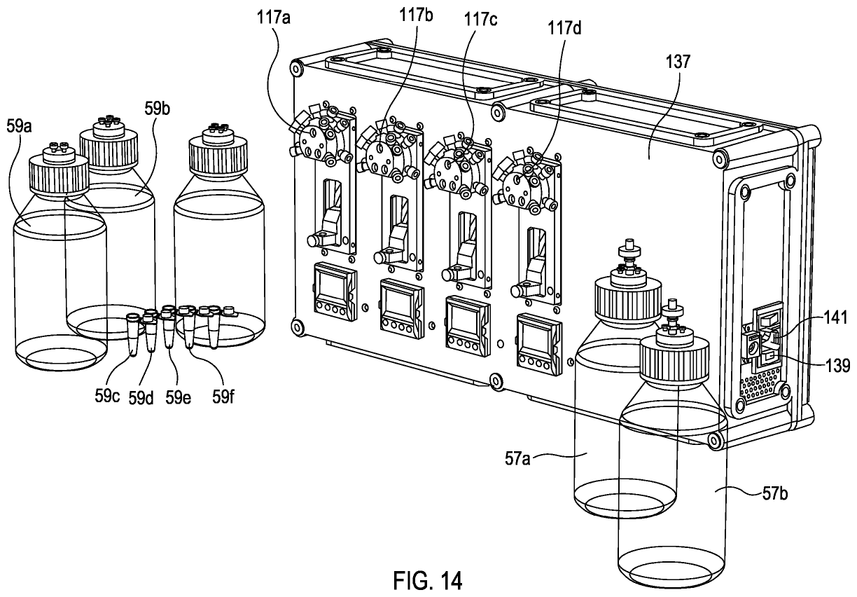

FIG. 14 illustrates an enclosure of the system of FIG. 13;

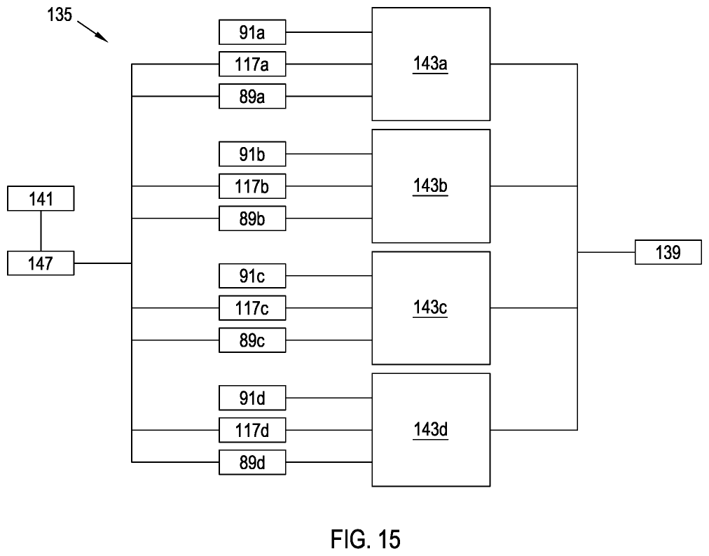

FIG. 15 illustrates the control electronics of the system of FIG. 13

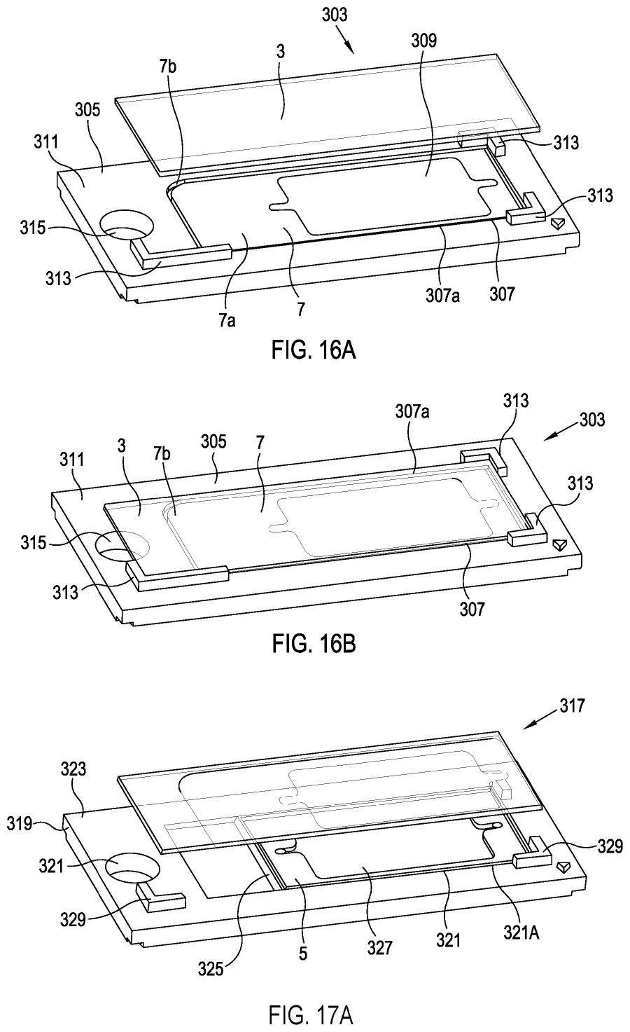

FIG. 16A illustrate a first guide of an assembly device for assembling a flow cell, before securing the slide to the gasket;

FIG. 16B illustrate the first guide of the assembly device for assembling a flow cell, after securing the slide to the gasket;

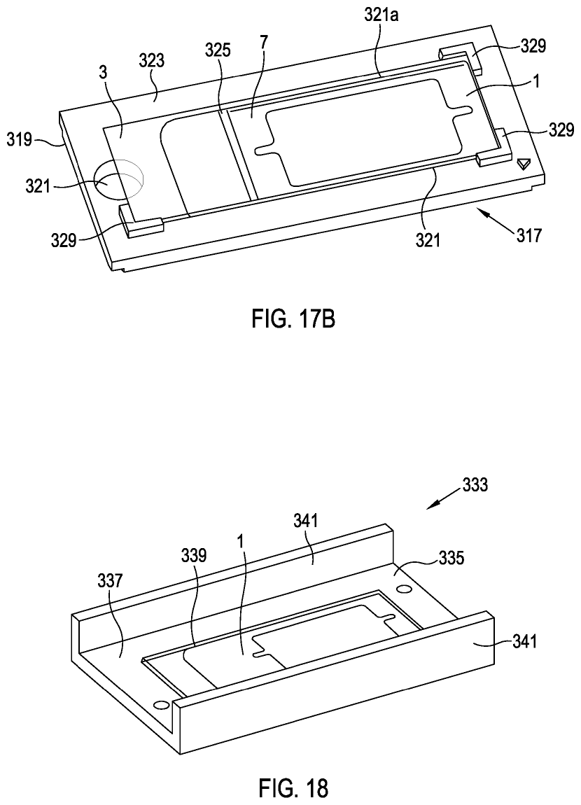

FIG. 17A illustrate a second guide of the assembly device for assembling a flow cell, before completing assembly of the flow cell;

FIG. 17B illustrate the second guide of the assembly device for assembling a flow cell, after completing assembly of the flow cell;

FIG. 18 illustrates a third guide of the assembly device for assembling a flow cell, for applying pressure to the assembled flow cell; and

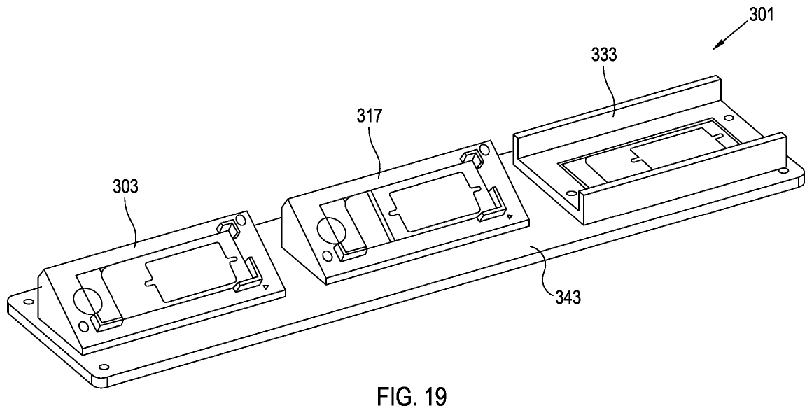

FIG. 19 illustrates the full assembly device.

FIG. 1 illustrates an example of a flow cell 1 for use in immunohistochemistry. In the example show, the flow cell 1 is made using a standard microscope slide 3 and coverslip 5. The microscope slide 3 is rectangular in shape having length of approximately 75 mm, width of approximately 25 mm and thickness of approximately 1 mm. The coverslip 5 is also rectangular, have similar or smaller length and width than the microscope slide 3 and 0.15 mm thick. For example, the coverslip may be 24 mm wide and 50 mm long. The microscope slide 3 and coverslip 5 are made of glass and transparent.

A rubber gasket 7 is provided between the microscope slide 3 and coverslip 5. The gasket 7 is rectangular in shape having length and width larger than or similar to the coverslip 5 and smaller than or similar to the microscope slide 3. The gasket 7 is 0.15 mm thick.

An opening 9 is formed extending through the thickness of the gasket 7. In the example shown, the opening 9 is substantially rectangular in shape, with projections 11, 13 extending at opposing ends along the length of the gasket 7. Apertures 15, 17 are formed in the coverslip 5, aligned with the projections 11, 13.

When the flow cell 1 is assembled, the gasket 7 is sandwiched between the microscope slide 3 and coverslip 5. Adhesive, or other suitable holding or fixing means may be used to ensure the flow cell 1 is held together. An enclosed volume 19 is formed, bounded by a perimeter wall 21 formed by the edge of the opening 9 in the gasket 7 and closed by the microscope slide 3 and coverslip 5 on opposite sides. Only the apertures 15, 17 open into the volume 19.

In use, a sample may be mounted on the microscope slide 3. The flow cell 1 is then assembled around this, as will be discussed in more detail below, with reference to FIGS. 16 to 19. The gasket 7 may be placed on the slide before or after the sample. The sample is imaged through the coverslip 5.

Reagents 23, such as markers 23a, or quenching reagents 23b are introduce to the flow cell 1 from reagent reservoirs 59a-d through a first of the apertures in the coverslip 5, forming a fluid input hole 15 and spent/quenched reagents are removed through the other aperture, forming a fluid output hole 17.

An adapter 25 for mounting a number of flow cells 1a, 1b 1c, 1d on a standard microscope stage of a histology microscope (not show), will now be described with reference to FIGS. 2 to 8. The adapter 25 may be provided in the place of the microscope stage insert.

The adapter 25 has a body 27 formed of two separate parts 29, 31-a base portion 29 and a top portion 31. The base portion 29 is shown in FIG. 2. FIGS. 3 to 6 and 8 show the body 27 of the adapter in an assembled state. FIG. 3 shows the body in cross-section through a flow cell 1, along the length of the flow cell 1. FIG. 4 shows the body in cross-section through the flow cells 1a-d, along the width of the flow cells.

The base portion 29 is rectangular in shape having a length longer than its width and defines four cavities 33a, 33b, 33c, 33d each sized to receive a flow cell 1a, 1b, 1c, 1d. The cavities 33a-d are arranged such that the length of the flow cells 1 extends across the width of the base portion 29.

The cavities 33a-d extend through the thickness of the base portion 29, to form an opening through which the samples in the flow cells 1a-d can be imaged. As best shown in FIGS. 3 and 8, a ledge 35 is formed at each end of the cavities 33a-d, extending parallel to the length of the base portion 29. The ledge 35 supports the ends of the flow cells 1a-d across their width.

In use, the flow cells 1a-d can be placed in the cavities 33a-d from above, with the coverslip 5 facing downwards. As will be discussed below the sample (not shown) is imaged form underneath the base portion 29.

The base portion 29 also includes ports 37a, 37b, 37c, 37d, 39a, 39b, 39c, 39d at each end of each of the cavities 33a-d. Each port 37a-d, 39a-d is formed in a projection extending upwards from the base portion 29, outside the cavities 33a-d. The projections are positioned such that they are clear of the microscope stage, in use.

At a first end of each of the cavities 33a-d the corresponding ports 37a-d form inlet ports for providing reagents to the flow cells 1a-d.

For each cavity, a first conduit 41a, 41b, 41c, 41d extends from a reagent reservoir 59a-f, and enters through the side of the base portion 29 at the opposite end of the cavities 33a-d to the inlet ports 37a-d. The first conduits 41a-c extend along the length of the cavities 33a-d at the side of the cavity 33a-d, beside the flow cells 1a-d. The first conduits 41a-d exit out of the base portion 29 adjacent the inlet ports 41a-d and then enter the inlet ports 41a-d.

The base portion 29 is formed with a thicker region 95 at either end of the cavities 33a-d. The thicker region 95 extends the full length of the adapter. The thicker region extends below the flow cells 1a-d when they are positioned in the cavities. This provides a thinner region 97, below the cavities.

The inlet ports 37a-d open into a second conduit 43a-d. The second conduit extends through the projection, the thicker region 95, and the ledge 35. A ferrule (not shown) is provided on the end of the first conduits 41a-d. The ferrule is received in the opening forming the inlet port 37a-d, and is pressed against the inlet ports 37a-d by a thumb nut 47a, 47b, 47c, 47d, which screws into the projection at the inlet port 37a-d. This ensures a fluid tight connection is formed where the first conduits 41a-d and second conduits 43a-d meet.

The second conduit 43a-d ends at an outlet 45 which is aligned with the fluid input hole 15 on the flow cell 1. The end of the conduit 43a-d abuts the flow cell around the fluid input hole 15. A recessed area 105 is formed in the ledge 35, around the outlet 45, and a seal 107 is received in the recessed area to form a seal between the conduit 43 and the flow cell 1.

The first conduits 41a-d and second conduits 43a, 43b, 43c, 43d form a fluid input channel for providing reagents to the flow cell 1. Both the first conduits 41a-d and second conduits 43a-d may be formed as flexing tubing, cavities or passages in the base portion 29, as a combination of the two, or by any other suitable means.

In the example shown, the first conduits 41a-d are formed by flexible tubing and the second conduits 43a-d by passages in the base portion 29.

A fluid outlet channel is formed by third conduits 49a, 49b, 49c, 49d and fourth conduits 53a, 53b, 53c, 53d.

The third conduits 49a-d extend from inlets 51a-d to outlet ports 39a-d. Like the second conduits 43a-d, the third conduits 49a-d extend through the ledge 35, the thicker portion 97 and the projection. The inlet 51a-d is aligned with the fluid output hole 17 of the flow cell 1. The end of the conduit 49a-d abuts the flow cell 1a-d. A recessed area 105 is formed in the ledge, around the outlet 45, and a seal 107 is received in the recessed area to form a seal between the conduit 43 and the flow cell 1.

Fourth conduits 53a-d (see FIG. 13) are provided from the outlet ports 39a-d to waste reservoirs 57. At the outlet ports 39a-d, the third conduits 49a-d and fourth conduits 53a-d are joined in a similar manner to the first conduits 41a-d and second conduits 43a-d. A ferrule (not shown) is formed on the end of the fourth conduits 53a-d. this is received in the opening forming the outlet port 39a-d, and is pressed into place by a thumb screw 55a-d which screws into the projection.

The third conduits 49a-d and fourth conduits 53a-d may be formed as flexing tubing, cavities or passages in the base portion 29, as a combination of the two, or by any other suitable means. In the example shown, the fourth conduits 53a-d are formed by flexible tubing and the third conduits 49a-d by passages in the base portion 29.

The top portion 31 of the body 27 overlies the base portion 29. The top portion 31 is also rectangular in shape and closes the tops of the cavities 33a-d in the base portion 29. The top portion is within the area bounded by the projections forming the inlet ports 37a-d and outlet ports 39a-d.

As best shown in FIGS. 3 and 4, an underside 61 of the top portion may include recesses 65 aligned with the flow cells 1a-d, such that the cavities 33a-d are formed in part by the base portion 29 and in part by the top portion 31. The height of the top portion 31 is such that the projections at the inlet and outlet ports 37a-d, 39a-d project above an upper surface 63 of the top portion 31.

The top portion 31 and bottom portion 29 are releasably fixed together to allow replacement of the flow cells 1a-d. In the example shown, thumb screws 67 having enlarged heads 67a to allow them to be tightened and loosened by hand are provided to secure the portions 29, 31 together.

As shown in FIG. 5, the thumb screws 67 are positioned at four corners of a rectangle formed by the area covered by the four flow cells 1a-d (i.e. the thinner area 97). The thumb screws 67 extend through the top portion 31 and bottom portion 29 away from the cavities 33a-d.

A biasing block 69a-d is provided in each cavity 33a-d, between the flow cell 1a-d and the top portion 31. A bottom surface 109 of the biasing block 69 contacts the microscope slide 3 of the flow cell 1a-d. The first conduit 41a-d of each fluid input channel 41, 43 runs adjacent the biasing block 69.

FIG. 6 shows a biasing block 69 in more detail. In order to fit in the cavity 33a-d, the biasing block is cuboid in shape, having length longer than width. A pair of first blind holes 71 are provided in the upper surface 111, spaced along the length the biasing block 69, centrally across the width.

As shown in FIGS. 3, a spring 73 is provided between the base 75 of the blind holes 71 and the underside 61 of the top portion 31. In the example shown, projections 77 extend down from the top portion 31, through the centre of the spring 73 to locate the spring 73.

The springs 73 apply a biasing force to urge the biasing block 69 away from the top portion 31, and press down on the flow cell 1a-d. This compresses the flow cell 1a-d together to ensure the flow cell is enclosed with a tight seal. Furthermore, this urges the flow cell 1a-d towards the outlet 45 of the fluid input channel 41, 43 and the inlet 51 of the fluid output channel 49, 53. Therefore, the flow cell 1a-d forms a fluid tight seal with the inlet channel 41, 43 and output channel 49, 53 prevent escape of reagents.

A further blind hole 79 is formed in the top surface 111, between the pair of first blind holes 71. The further blind hole 79 is also positioned centrally across the width. This aligns with an opening 81 through the top portion 31. A screw 83 extends through the top portion 31 into the further blind hole 79. Tightening or loosening of the screw 83 varies the force with which the biasing block 69 pushes down on the flow cell 1a-d.

A pair of elongate passages 85, 57 extend along the length of the biasing block 69 from an opening in one or both ends. The elongate passages 85, 87 are provided either side of the blind holes 71, 79. The heating element 89 is provided in the passage 85 closer to the conduit 41 for carrying reagents.

A heating element 89, and temperature probe 91 extend through the passages 85, 57. Connections to the heating element 89 and temperature probes 91 pass through the top portion 31 of the body and through opening 99 in the upper surface 63. A separate opening is provided for each heating element 89a-d and temperature probe 91a-d.

The biasing block 69 is made of a thermally conductive material such as aluminium, and may optionally be finished with an anodic film, such as Optical Black. Thus, when a current is passed through the heating elements 89 the biasing block 69 heats up. This in turn pre-heats the reagents as they pass through the first conduit 41a-d. This may also heart the contents of the flow cell 1a-d.

In use, the adapter 25, with four flow cells 1a-1d in place in the cavities 33a-d is held on a microscope stage. The adapter 25 is made of a standard size such that it can be held in place without modification of the microscope.

FIG. 8 illustrates the adapter 25 with an imaging apparatus 93 brought up to a flow cell 1. The reduced thickness region 97 allows the imaging apparatus to be brought closer to the sample in the flow cell 1a-d.

FIG. 9 illustrates a flow cell 1 according to a second embodiment. A second embodiment of an adapter 25, for use with the flow cell of FIG. 9, is described with reference to FIGS. 10 to 12. The flow cell 1 and adapter 25 shown in FIGS. 9 to 12 are the same as the flow cell 1 and adapter described in relation to FIGS. 1 to 8 unless explicitly stated otherwise. Like reference numerals will be used for like features.

The flow cell 1 of the second embodiment is identical in construction to the flow cell 1 of the first embodiment, except the fluid input hole 15 and fluid output hole 17 are provided in the microscope slide 3 rather than the coverslip 5.

In use, the sample to be examined is mounted on the coverslip 5, and the flow cell 1 assembled around this. This will be discussed in more detail below, in relation to FIGS. 16 to 19. As in the first embodiment, the assembled flow cell 1 is mounted on the adapter with the coverslip 5 facing down. Therefore, as will be described in more detail below, the adapter is arranged to deliver the fluid from above the flow cell 1 rather than below the flow cell 1, as in the first embodiment.

FIG. 10 shows a cross-sectional view of a single cavity 33 in the adapter 25 of the second embodiment, taken along the length of the cavity 33.

Unlike the first embodiment, there are no conduits 43, 49 formed in the ledge 35, thicker region 95 or bottom portion 29. In the first embodiment the ledge 35 and base portion extend sufficiently far under the flow cell 1 to reach the fluid inlet hole 15 and fluid outlet hole 17. In the second embodiment, this is not required, and the base portion 29 and ledge 35 simply have to support the flow cell 1. Therefore, the thinner region 97 is increased in size.

In the second embodiment, the fluid channels are formed in the biasing block 69. FIG. 11 shows the biasing block 69 of the second embodiment in more detail.

As in the first embodiment, the biasing block 69 includes a first pair of blind holes 71 for receiving springs 73 to resiliently bias the binding block 69 away from the top section 31 and towards the flow cell 1. Also, a further blind hole 79 is provided to receive the screw 83 to vary the biasing force.

In addition to the blind holes 71, 79, the biasing block in the second embodiment includes a pair of through passages 101, 103. The through passages 101, 103 are formed at either end of the line of blind holes 71, 79 and are formed centrally across the width of the biasing block 69. To accommodate the through passages 101, 103, the spacing of the blind holes 71, 79 along the length of the block is reduced in the second embodiment compared to the first embodiment.

A first through passage 101 of the pair of through passages aligns with the fluid inlet hole 15 in the microscope slide 3 in the flow cell, whilst the second through passage 103 aligns with the fluid output hole 17. The lower surface 109 of the biasing block 69 includes a recessed space 105′ around the ends 45′, 51′ of the through passages 101, 103. These recessed spaces 150′ are arranged to receive annular sealing members 107′ for forming a seal between the through passages 101, 103 and flow cell 1.

Upward extending projections 113, 115 extend from the upper surface 111 of the biasing block 69, around the through passages 101, 103, with the through passages continuing through the projections 113, 115.

The first projection 113 extends around the first through passage 101 and forms an inlet port 37a-d. Here, the through passages 101a-d connects to the conduits 41a-d that extend from the reservoirs source 59a,b. The connection may be by any suitable means, such as a ferrule and thumbscrew 47a-d, as disclosed in the first embodiment, or any other suitable connector. Therefore, the first through passage 101 has a corresponding function to the second conduits 43a-d in the first embodiment, and may be considered as a conduit forming part of the fluid inlet channel.

Likewise, the second projection 115 extends around the second through passage 103 and forms an outlet port 39a-d. Here, the through passage 103 connects to the conduits 53a-d that extends to the waste reservoir 57. The connection may be by any suitable means, such as a ferrule and thumbscrew 55a-d as disclosed in the first embodiment, or any other suitable connector. Therefore, the first through passage 103 has a corresponding function to the third conduits 49a-d in the first embodiment, and may be considered as a conduit forming part of the fluid output channel.

As shown in FIG. 12, the projections 113, 115 in the biasing block 69 extend through the top portion 31 of the body to allow for easy connection of the first conduits 41a-d and fourth conduits 49a-d.

As discussed above, the biasing block 69 of the second embodiment is urged downwards onto the flow cell 1. As in the first embodiment, this compresses the flow cell 1, forming a tight seal in the flow cell. This also acts to create a tight seal between the flow cell and the fluid input and output channels.

Referring to FIG. 11, it will be appreciated that the heating elements 89 and temperature probes 91 are arranged in the biasing block 69 in the same manner as the first embodiment. In this example, the reagents pass directly through the heated biasing block 69, and are pre-heated.

In the example shown in FIG. 12, a clamp 149 is provided. This holds down the heating elements 89 and temperature probes 91 to relieve strain. It will be appreciated that this is optional, and may be provided in any embodiment.

In the second embodiment, the removal of the fluid channels from the base portion 29 and underneath the flow cell 1 enables a greater part of the flow cell to be exposed, thus increasing the size of the viewing window of the flow cell.

A system 201 for immunohistochemistry analysis of samples provided in flow cells 1a-d mounted in adapters 25 as discussed above will now be described with reference to FIGS. 13 to 15. This system 201 is given by way of example only, and any suitable system may be used. It will be appreciated that the system is the same whether the flow cells 1a-d and adapter 25 of the first or second embodiment are used.

As shown in FIG. 13, reagents 23a-f are provided in reservoirs 59a-d. Any suitable type of reservoir may be used, such as by way of non-limiting examples, tanks, bottles, beakers, test tubes, vials, Eppendorf reservoirs and the like. The reagents 23a-f may be any suitable reagents, such as markers, quenching reagents and the like.

In one example a single reservoir may be provided for each reagent 23a-f. On the other hand, multiple reservoirs may be provided.

A multi-way pump 117 is provided for each individual flow cell 1a-d in the adapter 25. In the example shown a twelve way syringe pump is used, with 1 ml syringes and a minimum flow rate of between 10 μl/minute and 50 μl/minute. In some example, the flow rate may be between 20 μl/minute and 50 μl/minute

Each pump draws reagents 23a-f from the reservoirs 59a-f through conduits 121a-d, 123a-d, 125a-d, 127a-d, 129, 131. As can be seen in FIG. 13 separate conduits 121a-d, 123a-d may be provided for each pump 117a from the reservoirs 59a, 59b to the pump 117a. This may be the case for, for example, bulk reagents 23a, 23b . . . . On the other hand, other reagents 23c, 23d may be drawn from the reservoir 59c, 59d by a single conduit 125, 127, which then divides into separate branches 125a-d, 127a-d for each pump 117.

In some cases, reagents 23a-d are provided to every pump 117 and flow cell 1a-d. In other cases, certain reagents, 23e, 23f may be specific to a subset of one or more of the flow cells 1a-d.

One outlet of each pump 117a-d is connected to the flow cells 1a-d by the corresponding first conduit 41a-d. From the flow cell, reagents are carried to a waste reservoir 57b through outlet fluid channels 49, 103,53.

As discussed above, in the first embodiment, the fluid input channel includes a first conduit 41 that extends from the pump 117, through the base portion 41 adjacent the biasing block 69 and to an inlet port 37a-d. The fluid input channel then continues through a conduit 43 formed in the base portion 29 and ledge 35 of the adapter. The outlet channel extends through a first conduit 49 in the base portion 29 and ledge 35, through an outlet port 39a-d and through a second conduit 53.

On the other hand, in the second embodiment, the fluid input channel includes a first conduit 41 that simply extends to the inlet ports 37a-d. The second conduit then extends through the biasing block 69 to the flow cell 1a-d. The outlet channel extends through a first conduit 103 in the biasing block, to the output ports 39a-d and then through a second conduit 53a-d to the waste reservoir.

A second outlet of each pump 117 is connected directly to a bypass waste reservoir 57a, without passing through the flow cell. This is connected by bypass conduits 133a-d, and allows the system to be flushed, when required.

The pumps 117a-d and control electronics 135 may be housed in an enclosure 137 as shown in FIG. 14. The enclosure may be any suitable material, such as polycarbonate.

The pumps 117a-d and/or inlet and outlet ports of the pumps may be provided to the enclosure 137 to allow for connection of the system 201. Furthermore, as will be discussed below, a communications port 139, such as a USB or ethernet port, and power socket 141 may also be provided on the exterior of the enclosure. In other example, the communications may be wireless by WiFi, Bluetooth or other wireless communications.

FIG. 15 illustrates an example of the control electronics 135 required for operating the system 201 of FIG. 13.

A separate microcontroller 143a, 143b, 143c, 143d is provided for each flow cell 1a-d. The microcontrollers 143a-d receive communications over the communications port 139. Any suitable communications protocol may be used, and any suitable conversion or bridge may be provided, as required.

Each controller 143a-d is connected to the pump 117a-d and heating element 89a-d and temperature probe 91a-d of the corresponding flow cell 1a-d. This may be through any suitable communications, such as ethernet, relates, RS232, or any other suitable connection or driver. Furthermore, the heating elements 89a-d and pumps 117a-d may also be connected to a power supply 147.

The power supply 147 receives mains power from the power socket 143, and may include a regulator and/or inverter as required.

In one example use scenario, a set temperature for each flow cell 1a-d, is received over the communications socket 139. The controllers 143a-d then use the heating element 89a-d and temperature probe to achieve the desired temperature by selectively activating the heating element 89a-d using PID controls.

Commands may also be received over the communications socket when each pump should be activated, and which reagent should be pumped.

In this example, the operation of the system 201 is controlled remotely by a computer or external control device connected over the communications socket 139, which sends live instructions on when to activate each pump 117. The external control device may have pre-programmed routines that when started by a user, automatically run and send the required commands at the required times.

In other examples, the control electronics may include a memory that includes the desired set temperature and pump operations associated with predetermined routines. The command received over the interface may simply be a selected routine, which the controllers then perform.

On yet further examples, the operation may be distributed between the external control device and the controller 143a-d. Alternatively, a user may manual input each command required in turn.

The flow cells 1a-d discussed above are given by way of example only. The flow cell 1a-d may have any suitable arrangement and shape, with an inlet hole 15 and outlet hole 17 aligned with the fluid channels of the adapter 25.

For example, the opening 9 in the gasket 9 may have any suitable size and shape. The gasket 7 may be any suitable material that will elastically deformed when compressed to form a sealed enclosure 19.

Any suitable transparent plates of any shape and size and material can be used in place of the microscope slide 3 and coverslip 5.

In the example discussed above, the flow cell 1 is asymmetric along its length, because the coverslip 5 and gasket 7 are shorter in length than the microscope slide 3, and the fluid outlet hole 15 is spaced further from the end of the microscope slide 3 than the fluid inlet hole 13. This is by way of example only. The microscope slide 3, gasket 7 and coverslip 5 may be the same length and/or the fluid inlet hole 15 and fluid output hole 17 may be spaced equal distances form the respective ends of the microscope slide.

In one example, the apertures may be spaced by 43 mm. The opening 9 in the gasket 7 may be 36 mm by 20 mm. This may give an actual viewing area of 9 mm by 20 mm. This is by way of example only.

The adapter may be made of any suitable material. The top portion 29 and bottom portion 31 of the body may be made of metal, such as steel, plastics, ceramics, or any other material. The biasing block 69 may be made of any thermally conductive material.

The top portion 29 and bottom portion 31 may be releasable joined in any way. In the above examples, thumb screws 67 are used. However, the portions 29, 31 may be joined by one or more of: screws, latching points, clips, snap fit projections, and the like.

The biasing block 69 may be biased away from the top portion 69 in any suitable way. In the above example, two springs are used to create two biasing points. However, there may be any number of biasing points, and any biasing means may be used. Furthermore, the biasing block may extend over one or more edge of the flow cell, 1a-d, in which case, the biasing may act between the base portion 29 and the biasing block, to pull the biasing block towards the base portion.

In some examples, the biasing block 69 may be omitted. In this case, the spring 73 or other biasing means may act directly on the flow cell 1a-d, and the heating element 89 may be provided in another part of the body, with the fluid input channel run adjacent to or through the heated portion to pre-heat the reagents.

Any suitable heater or heating element may be used. In one example, the heater may have a power rating of 50 W but this is by example only. In one example, the heating element is a conductive wire, but any electrical or no electric heating element may be used. In some example, the passage 85 may be sealed and include a fluid, heated by an immersion heater, or there may be fluid exchange to cause heating.

Any type of temperature sensor 91a-d or thermocouple may be used.

The ledge 35 to support the flow cell 1a-d may only extend at the ends of the flow cell 1a-d, only at the sides of the flow cell 1a-d, or around the perimeter. The ledge 35 may be continuous or discontinuous around the ends and sides.

In the examples discussed above, the fluid inlet channel and fluid outlet channel are formed by two separate conduit portions. However, it may be that the channel, following the same path may be made of three or more separate portions joined together, or of a single continuous portion for each channel.

The examples shown above include four cavities 33a-d flow cells 1a-d in the adapter. However, it will be realised that the adapter may hold any number of flow cells, having one or more cavities 33. In some use scenarios, not all cavities may be filled, if the adapter includes more than one cavity 33.

Any number of reagents 23 may be coupled to the flow cells. Each reagent may be individually coupled to each flow cell, through a corresponding pump 117. Alternatively, some or all of the flow cells may be connected to the output of a single pump 117.

The conduits connecting the reservoirs to the pumps 117 and flow cells may be any suitable tubing, piping or other mechanism for conveying fluid.

The enclosure 137 and control circuitry discussed above is given by way of example only, and any suitable system 201 may be used to operate the flow cells 1a-d in the adapter 25.

An alignment device 301 for assembling a flow cell 1 he is shown in FIGS. 16 to 19.

The flow cell 1 assembled using the alignment device 301 may be used with the adapters 25 of either embodiments discussed above.

FIGS. 16A and 16B show a first guide 303 of the alignment device 301. The first guide 303 is used to apply the microscope slide 3 to the gasket 7.

The first guide 303 of the alignment device 301 is formed by a body 305 that is substantially rectangular in shape. The body 305 includes a recess 307 shaped and sized to tightly receive the gasket 7, and to hold the gasket 7 in place. The recess 307 has a boundary edge 307a which defines a perimeter for receiving the gasket 7.

The recess 307 has a flat base 309 for supporting the gasket 7. The depth of the recess 307 from the top surface 311 of the body 305 is such that when the gasket 7 is placed in the recess 307, the top surface 7a of the gasket 7 is flush with or just above the top surface 311 of the body 305.

Projections 313 extend upward form the top surface 311 of the body 305 of the first guide 303. The projections 313 define an edge to locate the slide 3 relative to the gasket 7. In the example shown, the projections 313 are discontinuous around the perimeter of the slide 3, and are provided at three corners, to allow the slide 3 to be accurately locate with respect to the gasket 7.

As discussed above, the gasket 7 is shorter in length than the slide 3. The projections 313 are arranged around the recess 307 such that the first guide 303 aligns one end of the gasket 7 at or substantially one end of the slide 3, and the sides of the gasket 7 at or substantially at the sides of the slide 3.

In the example shown in FIGS. 16A and 16B, the gasket 7 may have a curved corner 7b, with a corresponding curved corner formed in the recess. This ensures the gasket 7 can only be placed in the recess 307 in a single orientation in the recess 307, so the flow cell 1 is always assembled in the correct orientation.

As discussed above, adhesive is used to secure the slide 3, coverslip 5, and gasket 7 together. In one example, the gasket 7 may be have an adhesive pre-applied to both sides of the gasket 7, and protected by a protective film (not shown).

In a first step of assembling the flow cell 1, the protective film on the side of the gasket 7 facing the slide 3 is removed, the gasket 7 is placed in the recess 307, and then the slide is provided within the perimeter defined by the projections 313. The slide is then pressed onto the gasket 7 to secure the gasket 7 to the slide 3. The combined gasket 7 and slide 3 can then be removed as a single piece, forming a component part of the flow cell 1.

In the embodiment shown, a through hole 315 is provided through the body 305 of the first guide 303 to ease removal of the assembled gasket 7 and slide 3, although it will be appreciated that this is optional. As best shown in FIG. 16B, the through hole is aligned so that the edge of the slide 3 extends over the through hole 315.

FIGS. 17A and 17B schematically show a second guide 317 of the alignment device 301.

Like the first guide 303, the second guide 317 is formed by a body 319 that is substantially rectangular in shape. The body 319 includes a rectangular recess 321 formed in the top surface 323 of the body 319. The recess 321 is defined by a perimeter edge 321a, and is shaped and sized to receive the gasket 7. In the example shown, the recess 321 does not include a curved corner, but this may be incorporated in some examples.

As in the first guide 305, projections 329 extend upwards from the top surface 323 of the body 319. As in the first guide 305, the projections 329 are formed around the recess 321 and define an edge to locate the slide 3. In the example shown, the projections 329 are discontinuous around the perimeter of the slide 3, and are provided at three corners, to allow the slide 3 to be accurately locate with respect to the gasket 7.

The slide 3 and gasket 7 form separate but joined portions of the component part of the flow cell 1. When the component part is located in the second guide 317, the slide 3 rests on top of the top surface 323 of the body 319, and the gasket 7 sits in the recess 321.

A cross bar 325 extends across the width of the recess 321 nearer one end of the recess 321 than the other. The cross bar 325 and perimeter edge 321a of the recess define an area 327 to tightly fit and hold a coverslip 5.

The recess 321 has a base 321b on which the coverslip 5 can rest. The depth of the recess 321 is such that when the coverslip 5 is placed in the recess, the gasket 7 sits on the coverslip and the underside of the slide 3 sits on the top surface 323 of the body 319. The height of the cross bar 325 is such that the coverslip 5 is flush with or slightly above the top of the cross bar 325.

As discussed above, the coverslip 5 is shorter in length than the slide 3. The recess 321 in the second guide 317 is positioned to align one end of the coverslip 5 with the same end of the slide 3 to which the gasket 7 is also aligned. Therefore, at one end of the flow cell 1, the slide, 3, coverslip 5 and gasket 7 are all aligned. The sides of the coverslip 5 are aligned with the sides of the slide 3 and gasket 7.

In a second step of assembling the flow cell 1, the coverslip 5 is placed in the area 327 for receiving the coverslip 5. The protective film is then removed from the adhesive on the second side of the gasket 7, and the combined gasket 7 and microscope slide 3 placed in the recess 321, with the gasket 7 facing downwards towards the coverslip 5. The flow cell 1 is then pressed together to secure the parts together.

In the embodiment shown, a through hole 331 is provided through the body 319 of the second guide 317 to ease removal of the assembled flow cell 1, although it will be appreciated that this is optional. As best shown in FIG. 17B, the through hole 331 is aligned so that the edge of the slide 3 extends over the through hole 331.

When the adaptor 25 of the first embodiment is used, the sample to be inspected should be placed on the microscope slide 3. This can be done either before the first step discussed above, or between the first and second step.

When the adapter 25 of the second embodiment is used, the sample to be inspected should be placed on the coverslip 5. This can be done either before the first step discussed above, or between the first and second step. The sample may be placed on the coverslip 5 when the coverslip 5 is in the second guide 317, or before it is placed in the second guide 317.

In the steps for assembling the flow cell discussed above, the flow cell is pressed to secure the parts together. It will be appreciated that the flow cell should be pressed until wetting of the slide 3 or coverslip 5 can be seen through the adhesive, and to remove as many air pockets form the adhesive as possible.

In one example, a roller may be used to apply pressure to the assembled flow cell 1. FIG. 17 illustrates an optional third guide 333 for applying pressure to the flow cell 1.

In FIG. 18, the third guide 333 is formed by a body 335 having a flat top surface 337. A recess 339 is formed in the flat surface 337. The recess 339 is shaped and sized to tightly receive the flow cell 1 with the coverslip 5 facing upwards. The depth of the recess 339 is such that when the flow cell 1 is properly assembly, the top of the flow cell 1 should be flush with the top surface 337 of the body 335, or just above it.

Sidewalls 341 are formed along the long edges of the body 335, extending upward from the top surface 337 and parallel to the long edges of the flow cell. The ends of the body 335 are open.

In use, a roller (not shown) sized to fit between the side walls 341 can be used to apply pressure to the flow cell. The arrangement of the third guide 333 ensures that the pressure is evenly applied.

An opening may be provided under the flow cell 1 or at an edge of the flow cell, to allow the flow cell 1 to be pushed out of the recess 339.

Any suitable roller may be used. For example, a 40 shore soft rubber roller with 20 mm diameter may be used.

It will be appreciated that the roller is only one example for applying pressure. For example, a clamp or screw system (similar to a book press) may also be used to apply pressure. In some examples, pressure may be applied the flow cell 1 with the slide 3 facing up instead of or as well as with the coverslip 5 facing up.

In one example, the guides 303, 317, 333 may be arranged such that they lie parallel to any surface they are placed on. In other examples, the first and second guides 303, 317 may be inclined to ensure the constituent parts of the flow cell 1 sit against the edges/projections defining their position. The guides 303, 317 may be tilted along their long axis or across their long axis.

The separate guides 303, 317, 333 may be colour coded or have writing or other markers to help the user follow the correct procedure for assembling the flow cell 1. The guides may be made of any suitable material, such as plastics, metal or the like.

In one example, the guides 303, 317, 333 of the assembly device 301 may be provided separately. In other examples, such as shown in FIG. 19, the three guides 303, 317, 333 may be provided on a base 343. The guides 303, 317, 333 may be arranged such that the long dimension of the guides 303, 317, 333 is parallel to the long dimension of the base or perpendicular, or in any other arrangement.

The assembly device 301 discussed above is just one example of how to assembly a flow cell 1. Any suitable guidance/alignment device may be used. In some example, the flow cell 1 may simply be assembled by hand.

In the above example, separate guides 301, 317, 333 are used to locate the slide 3 relative to the gasket 7 and then the combined slide/gasket relative to the coverslip 5. It will, however, be appreciated that the recesses may be arranged such that a single guide may be used to assemble the flow cell 1. In the example discussed above, a separate guide 33 is provided for applying pressure, but this may not necessarily be the case. Pressure may be applied in a guide also used for assembly. Furthermore, the step of applying pressure using a roller or the like may be omitted altogether.

Furthermore, in the guides discussed above, recesses and projections are used to form locating edges to position to constituent parts of the flow cell 1. This is by way of example only, and any suitable locating features may be used. The locating features may be continuous around the perimeter of the flow cell 1, or discontinuous.

Any suitable adhesive may be used. In one example, the adhesive may require heat treatment, although it should be ensured that any heat will not degrade the sample under inspection.

In the example discussed above, the curved corner of the gasket to help provide the correct orientation of the gasket 7. This is optional, and may be omitted, or any other orienting feature may be provided. The curved corner also enable the protective film to be easily removed from the adhesive. However, tabs, hooks or other features may be provided for this reason.

The features of the adhesive discussed above, such as the protective film for the adhesive and the curved corner are by way of example only. It will be further appreciated that these features may be applied to any embodiment of the flow cell 1, and are not limited to use with the assembly device 301 discussed above.

In the above example, the gasket 7 fixed to the slide 3 and then the coverslip 5 is added. This is by way of example only, and the order of assembly of the flow cell 1 may be varied.

1. A flow cell adaptor for use in cyclic histology, the flow cell adaptor having a body defining a cavity configured to removably receive a flow cell, wherein the adaptor has a fluid input channel configured to direct one or more reagents to a flow cell, and a fluid output channel configured to receive one or more reagents from a flow cell, wherein the flow cell adaptor comprises a heater configured to heat the one or more reagents in the fluid input channel.

2. The flow cell adaptor of claim 1, wherein the cavity is sized to fit a flow cell which comprises a microscope slide, and wherein the flow cell and an outlet of the fluid input channel and an inlet of the fluid output channel are biased such that they are urged together.

3. (canceled)

4. The flow cell adaptor of claim 1, wherein the body is formed of two or more parts which are removably fixed together such that the flow cell can be removed from the cavity.

5. The flow cell adaptor of claim 4, wherein the adaptor includes a biasing block which is received at least partially within the cavity, and wherein the biasing block is urged away from a first portion of the body towards the flow cell, which in turn urges the fluid input and output channels and the flow cell together.

6. The flow cell adaptor of claim 5, wherein the biasing block incorporates the heater such that the heater heats the block.

7. The flow cell adaptor of claim 5, wherein at least a portion of the fluid input channel runs through the biasing block to pre-heat the one or more fluids.

8. (canceled)

9. The flow cell adaptor of claim 1, wherein the body defines an opening through which contents of the flow cell can be imaged.

10. The flow cell adaptor of claim 1, wherein the body comprises a ledge configured to support the flow cell.

11. The flow cell adaptor of claim 10, wherein, in use, the flow cell is supported by the ledge at opposing ends only.

12. (canceled)

13. The flow cell adaptor of claim 10, wherein a portion of the fluid input channel and a portion of the fluid output channel are both routed through the ledge.

14. (canceled)

15. The flow cell adaptor of claim 1, wherein the body defines a plurality of cavities, each cavity being configured to removably receive a flow cell, wherein the adaptor has a plurality of fluid input channels, each fluid input channel configured to direct one or more reagents to a respective flow cell, and a plurality of fluid output channels, each fluid output channel configured to receive one or more reagents from a respective flow cell, wherein the flow cell adaptor comprises one or more heaters configured to heat the one or more reagents in the fluid input channels.

16. (canceled)

17. A system for performing cyclic histology, the system comprising:
a flow cell comprising:
a first plate;
a second plate;
a gasket between the first and second plates, wherein the gasket includes an opening extending therethrough, the opening defined by a perimeter wall, such that an enclosed volume is formed by the first plate, the second plate, and the perimeter wall; and
one or more fluid input holes in one of the first plate or the second plate, and one or more fluid output holes in the one of the first plate or the second plate, the one or more fluid input holes and one or more fluid output holes aligned with the enclosed volume, and
a flow cell adaptor for use in cyclic histology, the flow cell adaptor having a body defining a cavity configured to removably receive a flow cell, wherein the adaptor has a fluid input channel configured to direct one or more reagents to a flow cell, and a fluid output channel configured to receive one or more reagents from a flow cell, wherein the flow cell adaptor comprises a heater configured to heat the one or more reagents in the fluid input channel wherein the fluid input channel is configured to direct one or more fluids to the one or more fluid input holes, and the fluid output channel is configured to receive one or more fluids from the one or more fluid output holes.

18. (canceled)

19. (canceled)

20. (canceled)

21. The system of claim 17, comprising two or more flow cells, wherein the body of the flow cell adaptor defines two or more cavities, each cavity configured to removably receive a flow cell, wherein the adaptor has one or more fluid input channels configured to direct one or more reagents to the fluid input holes, and one or more fluid output channels configured to receive one or more reagents from the fluid output holes.

22. A device for assembling a flow cell comprising a first plate, a second plate, and a gasket between the first plate and the second plate, the device including:
a first guide arranged to locate the gasket relative to one of the first plate and second plate, for forming a component part of the flow cell comprising the gasket attached to the one of the first plate and second plate; and
a second guide arranged to locate the component part of the flow cell relative to the other of the first plate and second plate, for forming the assembled flow cell.

23. The device of claim 22, further including:
a third guide arranged to locate the assembled flow cell such that pressure may be applied to the flow cell, to ensure adhesion of the first plate, the second plate, and the gasket, and wherein the third guide locates the flow cell relative to a planar surface to which pressure is applied, such that the flow cell is substantially flush to the surface.

24. (canceled)

25. The device of claim 22, wherein the first guide and/or the second guide are inclined relative to a surface on which the device is placed.

26. The device of claim 23, wherein the first guide, the second guide, and the third guide where provided, comprise an edge to locate the first plate, second plate, gasket or component part of the flow cell, and wherein the edge is formed by a recess extending into a planar surface or a projection extending from the planar surface, and wherein the first guide and/or second guide comprise both a recess extending into a planar surface, and projections extending from the planar surface, arranged around the recess.

27. (canceled)

28. (canceled)

29. (canceled)

30. The device of claim 26 wherein:
in the first guide, the recess is arranged to locate the gasket and the projections are arranged to locate the one of the first plate and the second plate relative to the gasket; and
in the second guide, the recess is arranged to locate the other of the first plate and the second plate and a first portion of the component part, and the projections are arranged to locate a second portion of the component part.

31. The device of claim 26, wherein the recess and corresponding first plate, second plate or gasket are shaped to only allow placement of the first plate, second plate or gasket in a single orientation.

32. (canceled)

33. (canceled)

34. (canceled)

35. The device of claim 26, wherein the first guide and/or the second guide comprises a through hole aligned with the edge of the flow cell.

36. (canceled)

37. (canceled)

38. (canceled)

39. (canceled)
